(19) United States
(12) Patent Application Publication
(10) Pub. No.: US 2015/0111989 A1
(43) Pub. Date: Apr. 23, 2015

(54) SET OF INK AND PRETREATMENT LIQUID

(71) Applicant: Seiko Epson Corporation, Tokyo (JP)

(72) Inventor: Takayoshi KAGATA, Shiojiri (JP)

(21) Appl. No.: 14/518,201

(22) Filed: Oct. 20, 2014

(30) Foreign Application Priority Data
Oct. 21, 2013 (JP) 2013-218099

(51) Int. Cl. C09D 11/322

(52) U.S. Cl. CPC C09D 11/322
USPC 523/218

(57) ABSTRACT

A set of an ink and a pretreatment liquid includes a white-based ink composition containing a white-based color material and a pretreatment liquid containing a flocculant, in which the white-based color material consists of second particles which have an average particle size from 200 nm to 1 μm and which are formed by aggregating a plurality of first particles having an average particle size of less than 200 nm, in which the flocculant flocculates the second particles, and in which the white-based ink composition is preferably adhered onto a region of a recording medium onto which the pretreatment liquid is imparted so that the white-based color material is 0.1 mg/cm² or more.

### BACKGROUND

1. Technical Field

The present invention relates to a set of an ink and a pretreatment liquid.

2. Related Art

In the related art, an image having a variety of colors has been formed on a recording medium using a color ink such as a cyan ink, a magenta ink, a yellow ink, or a black ink. In recent years, an ink capable of forming an image having color which cannot be expressed by only such a color ink is attracting attention. For example, in JP-A-6-322306, a white-based ink composition containing a white-based color material such as titanium dioxide is disclosed. Such a white-based ink composition can form a white-based image which cannot be formed by the color ink described above.

In a case where a color image is recorded on a recording medium like, for example, a plastic product or a metal product in which the color of the foundation is not necessarily white, a white-based ink composition containing the white-based color material is sometimes used for the purpose for erasing the color of the foundation, in order to enhance color developing properties of the color image. In addition, in a case where the color image is recorded on a transparent sheet, the white-based color material is sometimes used for forming a white shielding layer which decreases the permeability of the color image. Therefore, when the white-based ink composition is adhered to the recording medium, high brightness has been required.

However, if the white-based color material represented by titanium dioxide as described above does not have a large particle size to some extent (for example, approximately 200 nm or more), there is a tendency to feel lacking the whiteness of the image which is recorded. Therefore, it is preferable to increase the particle size of the white-based color material in order to increase the brightness, however, there is a problem in that the white-based color material is precipitated in the ink composition, accompanied by an increase in particle size of the white-based color material. With respect to such a problem, for example, in JP-A-2007-211176 and Japanese Patent No. 4958001, the use of porous titanium dioxide particles as a white-based color material is described. When the porous white-based color material is used, it is possible to make the specific gravity thereof lower than that of the white-based color material using titanium dioxide in the related art.

In a case of using the porous titanium dioxide particles as described above, it is possible to improve the sedimentation of the white-based color material, however, a further enhancement of brightness is required in order to increase concealing properties and color developing properties of the white-based image which is recorded.

### SUMMARY

An advantage of some aspects of the invention is to provide a set of a white-based ink composition and a pretreatment liquid, in which the sedimentation of the white-based color material is suppressed and an image excellent in brightness can be formed.

The invention can be realized in the following forms or application examples.

### APPLICATION EXAMPLE 1

According to Application Example 1, there is provided a set of a white-based ink composition and a pretreatment liquid including a white-based ink composition containing a white-based color material and a pretreatment liquid containing a flocculant, in which the white-based color material consists of second particles which have an average particle size from 200 nm to 1 μm and which are formed by aggregating a plurality of first particles having an average particle size of less than 200 nm, and in which the flocculant flocculates the second particles.

According to the set of a white-based ink composition and a pretreatment liquid of Application Example 1, the sedimentation of the white-based color material is suppressed and an image excellent in brightness can be formed.

### APPLICATION EXAMPLE 2

In Application Example 1, the white-based ink composition may be adhered onto a region of a recording medium onto which the pretreatment liquid is imparted so that the white-based color material is 0.1 mg/cm² or more.

### APPLICATION EXAMPLE 3

In Application Example 1 or Application Example 2, the white-based ink composition further includes a resin and the content of the white-based color material may be from 0.2 times to 20 times in terms of a solid content with respect to the content of the resin.

### APPLICATION EXAMPLE 4

In any one of Application Example 1 to Application Example 3, the white-based ink composition is used for an ink jet recording apparatus, in which the ink jet recording apparatus may be provided with a pressurizing section for pressurizing an image obtained by adhering the white-based ink composition onto a recording medium.

### APPLICATION EXAMPLE 5

In any one of Application Example 1 to Application Example 4, the white-based ink composition is an ultraviolet ray curable type ink which is cured by irradiating with an ultraviolet ray and may include a polymerizable compound.

### APPLICATION EXAMPLE 6

In any one of Application Example 1 to Application Example 5, the white-based ink composition may be used for recording to an ink-non-absorbing recording medium.

### APPLICATION EXAMPLE 7

In any one of Application Example 1 to Application Example 6, the white-based ink composition may be brought into contact with the pretreatment liquid in a state in which the pretreatment liquid adhered onto a recording medium is wet.

### APPLICATION EXAMPLE 8

In any one of Application Example 1 to Application Example 7, the white-based ink composition is used for an ink jet recording apparatus, in which the ink jet recording apparatus is provided with a nozzle forming surface on which a nozzle discharging an ink is arranged, a wiping section for wiping the nozzle forming surface, and a cleaning liquid imparting section for imparting a cleaning liquid to the wiping section or the nozzle forming surface, in which the surface tension of the cleaning liquid may be from 20 mN/m to 45 mN/m.

### BRIEF DESCRIPTION OF THE DRAWINGS

The invention will be described with reference to the accompanying drawings, wherein like numbers reference like elements.

FIG. 1 is a perspective view schematically showing a configuration of an ink jet recording apparatus according to the invention.

FIG. 2 is a schematic view schematically showing a nozzle forming surface of a head in an ink jet recording apparatus according to the invention.

FIGS. 3A and 3B are SEM images showing states before and after the flocculation of a white-based color material according to Example 2.

FIGS. 4A and 4B are SEM images showing states before and after the flocculation of a white-based color material according to Comparative Example 2.

### DESCRIPTION OF EXEMPLARY EMBODIMENTS

Hereinafter, description will be given of suitable embodiments of the invention. The embodiment described below is intended to describe an example of the invention. In addition, the invention is not limited to the following embodiment and also includes various Modification Examples which are performed in a range without changing the gist of the invention.

### 1. Set of White-Based Ink Composition and Pretreatment Liquid

A set of a white-based ink composition and a pretreatment liquid according to an embodiment of the invention includes a white-based ink composition containing a white-based color material and a pretreatment liquid containing a flocculant, in which the white-based color material consists of second particles having an average particle size from 200 nm to 1 μm which are formed by aggregating a plurality of first particles having an average particle size of less than 200 nm, and in which the flocculant flocculates the second particles.

As long as the set of a white-based ink composition and a pretreatment liquid according to the invention includes at least a white-based ink composition and a pretreatment liquid, the set of a white-based ink composition and a pretreatment liquid may be one in which other ink compositions (for example, a color ink composition such as a cyan, magenta, yellow, or black ink composition) are included.

In the invention, the white-based ink composition is an ink capable of recoding color which is referred to as “white” under the social standards and also includes one which is colored with minute amount. In addition, the white-based ink composition includes an ink in which an ink containing the pigment is referred to and sold as a name like “a white ink” or the like. Furthermore, for example, in a case where an ink is recorded on Epson genuine photo paper <glossy> (manufactured by Seiko Epson Corp.) with 100% duty or more or with an amount in which the surface of a photo paper is sufficiently covered and in a case where the luminosity (L*) and the chromaticity (a* and b*) of ink are measured using a spectrophotometer Spectrolino (trade name, manufactured by GretagMacbeth GmbH) by respectively setting a light source, the observation field of view, the concentration, the white standard, the filter, and the measurement mode to D50, 2°, DIN NB, Abs, No, and Reflectance as measurement conditions, the white-based ink composition includes an ink indicating a range of 70≦L*≦100, −4.5≦a*≦2, and −6≦b*≦2.5.

In the definition of the white-based ink, “duty” is a value which is calculated by the following expression.

duty(%)=the number of actual discharged dots/(the lengthwise resolution×the crosswise resolution)×100

(In the expression, “the number of actual discharged dots” is the number of actual discharged dots per unit area and “the lengthwise resolution” and “the crosswise resolution” are respectively the resolutions per unit length.)

Hereinafter, as to the set of a white-based ink composition and a pretreatment liquid according to the embodiment (hereinafter, also simply referred to as “an ink set”), detailed description will be given of a white-based ink composition and a pretreatment liquid in this order.

### 1.1. White-Based Ink Composition

### 1.1.1. White-Based Color Material

A white-based ink composition included in the ink set according to the embodiment contains a white-based color material. The white-based color material consists of second particles which are formed by aggregating a plurality of first particles having an average particle size of less than 200 nm and the average particle size of the second particles is from 200 nm to 1 μm. In this manner, since the second particles are formed by aggregating a plurality of minute first particles, many holes (voids) are formed on the surface of the second particles. Thereby, since the dispersion medium can enter the voids of the second particles, the dispersibility of the second particles (the white-based color material) in the white-based ink composition becomes excellent. Furthermore, since the specific gravity of the second particles is smaller compared to that of the white-based color material having the same particle size in which many holes do not formed on the surface, the second particles become difficult to be precipitated in an ink.

The content (in terms of solid content) of the white-based color material is preferably from 1% by mass to 20% by mass and more preferably from 5% by mass to 15% by mass, with respect to the total mass of the white-based ink composition. When the content of the white-base ink color material is within the range described above, the white-based ink composition excellent in dispersibility is easily obtained and an image excellent in color developing properties is easily obtained.

### First Particle

The average particle size of the first particles is required to be less than 200 nm, however, is preferably 50 nm or more and less than 200 nm, is more preferably from 60 nm to 150 nm, and is particularly preferably from 70 nm to 110 nm. When the average particle size of the first particles is less than 200 nm, even in a case where the first particles which do not configure the second particles exist in an ink, it is possible to suppress the sedimentation of the first particles. In addition, when the particle size of the first particles is 50 nm or more, in a case where the first particles which do not configure the second particles exist in an ink, the first particles contribute to enhancing the brightness of the image though the effect thereof is lower compared to that of the second particles. On the other hand, when the average particle size of the first particles becomes 200 nm or more, the particle size of the second particles formed using these becomes too large, and thus there are some cases of causing sedimentation in an ink, the discharge failure, or the like.

The average particle size of the first particles can be measured based on the image which is obtained by a scanning electron microscope (SEM). Specifically, the average particle size of the first particles means an arithmetic mean value of values obtained by selecting 10 particles and respectively measuring these diameters after 10 particles from the particles having the largest particle size in decreasing order and 10 particles from the particles having the smallest particle size in increasing order are removed in the image which is obtained by a scanning electron microscope.

The first particles preferably include at least one kind of compound selected from a metal oxide (for example, titanium dioxide, zinc oxide, silica, alumina, magnesium oxide, zirconium dioxide, yttria stabilized zirconium, indium oxide, antimony oxide, tin oxide, barium titanate, or the like), barium sulfate and calcium carbonate. These compounds may be used as one kind alone or may be used in combination of two or more kinds thereof. Among these compounds, it is more preferable to use a metal oxide and it is further more preferable to be titanium dioxide, zirconium dioxide, and silica, from the viewpoint of the brightness, shielding properties, and the physical strength. Moreover, the first particles may have a so-called core shell structure in which one kind or more of compounds are covered by one kind or more of compounds.

The first particles are manufactured by a well-known method of manufacturing, and specifically, a method of manufacturing such as a grinding method or a synthesis method (for example, an evaporation condensation method, a gas phase reaction method, a colloidal method, a homogeneous precipitation method, a hydrothermal synthesis method, a microemulsion method, or the like) is included.

For the first particles, commercial products may be used and, for example, TTO-51 (A), TTO-51 (C), TTO-55 (A), TTO-55 (B), TTO-55 (C), and TTO-55 (D) manufactured by Ishihara Sangyo Kaisha, Ltd., MT-700B, JR-301, JR-403, JR-405, JR-600A, JR-605, JR-600E, JR-603, JR-805, JR-806, JR-701, JRNC, JR-800, JR, JA-1, JA-C, and JA-3 manufactured by TAYCA CORPORATION (hereinbefore, all trade names), and the like are included.

In addition, the first particles may be particles which are surface-treated by a surface treatment agent such as a silane coupling agent (for example, γ-glycidoxypropyltrimethoxysilane or the like), a polymer such as polyvinylpyrrolidone or polyvinyl alcohol, or an organic acid. Thereby, since a group derived from the surface treatment agent is introduced on the surface of the first particles, it is possible to enhance the dispersibility of the first particles in a medium.

Moreover, the white-based ink composition may contain the first particles which are separated from the second particles.

### Second Particle Before Flocculation

The second particles (the white-based color material) included in the white-based ink composition are particles which are formed by aggregating a plurality of first particles. In the invention, the second particles before flocculating by an action of the pretreatment liquid described below are referred to as “the second particles before the flocculation” and the second particles after flocculating by an action of the pretreatment liquid described below are referred to as “the second particles after the flocculation”. In addition, in the invention, in a case of mentioning simply “the second particles”, this indicates “the second particles before the flocculation” and is distinguished from “the second particles after the flocculation”.

The average particle size of the second particles (the white-based color material) is required to be from 200 nm to 1 μm, however, is preferably from 250 nm to 800 nm, is more preferably from 270 nm to 600 nm, and is particularly preferably from 300 nm to 500 nm. When the average particle size of the second particles is 200 nm or more, the brightness of the image which is recorded becomes excellent. In addition, when the average particle size of the second particles is 1 μm or less, it is possible to suppress the sedimentation of the second particles and the discharge stability becomes excellent when applying the second particles to a liquid droplet discharging apparatus. On the other hand, when the average particle size of the second particles is less than 200 nm, there is a tendency to lack the brightness of the image which is recorded, and when the average particle size of the second particles exceeds 1 μm, there are some cases where the second particles are easily precipitated and the discharge failure is caused.

The average particle size of the second particles means a volume average particle size calculated from the particle size distribution after the particle size distribution on a volume basis is determined by detecting a light intensity distribution pattern of a diffraction scattering light using a laser diffraction particle size distribution measuring apparatus and calculating the light intensity distribution pattern based on Mie scattering theory. As such a laser diffraction particle size distribution measuring apparatus, for example, MICROTRAC UPA (manufactured by Nikkiso Co., Ltd.) is included.

The second particles (the white-based color material) include the first particles described above and may further include organic polymer particles. If the organic polymer particles are used, it becomes easier to aggregate a plurality of first particles to make one particle (the second particles). As organic polymer particles, it is preferable to use the organic polymer particles capable of being dispersed in a water-based medium and, for example, a water-insoluble organic polymer particles obtained by using at least one kind selected from polyolefin, poly(meth)acrylic acid, polystyrene, polyurethane, polyacrylonitrile, polyvinyl chloride, polyvinylidene chloride, polyvinyl acetate, polybutadiene, or the like, as a raw material are included.

The average particle size of the organic polymer particles is preferably from 10 nm to 300 nm and more preferably from 10 nm to 200 nm. In a case where the second particles include the organic polymer particles, the ratio of the organic polymer particles in the second particles to the first particles can be set from 10:90 to 90:10 as a mass ratio. The average particle size of the organic polymer particles means a volume average particle size which is calculated from the particle size distribution measured using the same method and measuring apparatus as those of the second particle size.

The second particles are porous particles having a plurality of holes on the surface. The average pore size of the hole of the second particles is preferably from 10 nm to 300 nm and more preferably from 10 nm to 200 nm. The average pore size in the invention indicates an average pore diameter which is calculated from the total pore volume and the specific surface area. Moreover, the total pore volume and the specific surface area can be calculated based on the pore distribution which is obtained by a gas absorption method (nitrogen gas is used), and specifically, it is possible to calculate the total pore volume using a BJH method and the specific surface area using a BET method. As an apparatus capable of performing a gas absorption method, for example, AUTOSORB 3 (product name) manufactured by Quantachrome Corporation, and the like are included.

The porosity of the second particles is not particularly limited, however, for example, can be from 20% to 90%, furthermore, can be from 30% to 85%. The porosity is calculated based on the total pore volume described above.

### Method of Manufacturing White-Based Color Material (the Second Particles)

The method of manufacturing the white-based color material (the second particles) is not particularly limited, however, for example, it is possible to manufacture by performing the following processes (i) to (iii). In the following processes, description will be given of a case of using a metal oxide as first particles as an example.

The process (i) is a process of preparing a mixed liquid which is mixed or reacted with an aqueous dispersion of the organic polymer particles using an aqueous dispersion of the first particles.

The aqueous dispersion of the first particles is obtained by adding the first particles to the water-based medium and then stirring the mixture. In order to enhance the water-dispersibility in the water-based medium, the first particles into which the surface treatment agent described above is introduced may be used to be added to the water-based medium or the first particles may be added to the water-based medium including the surface treatment agent described above. The aqueous dispersion of the organic polymer particles is obtained by adding the organic polymer particles to the water-based medium and then stirring the mixture. By mixing and stirring each aqueous dispersion thus obtained, a mixed liquid containing the first particles and the organic polymer particles is obtained.

As a water-based medium, at least one of water and a polar organic solvent can be used. The polar organic solvent is not particularly limited, however, for example, methanol, ethanol, propyl alcohol, isopropyl alcohol, acetonitrile, dimethyl sulfoxide, dimethylformamide, acetone, tetrahydrofuran, dioxane, and the like are included.

Moreover, as a process (i), a method of preparing a reaction solution by a sol-gel reaction using a precursor of a metal oxide in presence of the organic polymer particles may be employed, instead of the method described above. Specifically, the reaction solution is obtained by mixing the organic polymer particles, the precursor of a metal oxide, the water-based medium, the sol-gel reaction catalyst, or the like at an arbitrary proportion in accordance with a reaction condition. As a precursor of a metal oxide, for example, a metal alkoxide configuring the metal oxide (for example, titanium tetraisopropoxide or the like) or the like can be used. In addition, as a sol-gel reaction catalyst, for example, an acid catalyst (an inorganic and organic acid or the like) and an alkali catalyst (an alkali metal hydroxide, amines, or the like) can be used.

The process (ii) is a process of drying the mixed liquid obtained by the process (i). Thereby, an organic-inorganic complex including the first particles and the organic polymer particles is obtained.

The organic-inorganic complex can be manufactured, for example, by pulverizing or the like a solid obtained by heat-drying the mixed liquid, pulverizing a solid obtained by heat-drying after freeze-drying the mixed liquid, or drying after spraying the mixed liquid.

In a case where the mixed liquid is heat-dried, it is preferable to perform the heat-drying under a condition from 20° C. to 300° C. and it is more preferable to perform the heat-drying under a condition from 80° C. to 200° C. Thereby, the organic polymer particles are easily dispersed and arranged in a matrix configured of a plurality of first particles.

In addition, by classifying the obtained organic-inorganic complex by using a well-known sieving apparatus or the like after performing the pulverization or the like, it becomes easier to obtain the organic-inorganic complex having a desired average particle size.

The process (iii) is a process of removing at least a part of the organic polymer particles which exist in the organic-inorganic complex obtained by the process (ii). Thereby, it is possible to obtain the second particles formed by aggregating a plurality of first particles. The obtained second particles are porous particles having approximately uniform holes on the surface.

As a method of removing the organic polymer particles, a method of calcinating by heating, a method of irradiating with plasma, a far infrared ray, a microwave, a vacuum ultraviolet ray, or the like, and a method of removing by eluting using a solvent, water, or the like are included. In a case of removing the organic polymer particles by calcinating, the calcination temperature is preferably set from 300° C. to 2,000° C., more preferably set from 400° C. to 1,000° C., and further more preferably set from 500° C. to 800° C. When the calcination temperature is set to be within the range described above, it is possible to properly remove the organic polymer particles which exist on the surface of the organic-inorganic complex. In addition, since the crystallite size becomes stabilized and it is possible to suppress melting of oxide particles, the holes generated by removing the organic polymer particles are excellently formed.

Second Particles after Flocculation

The second particles after the flocculation means a state in which a plurality of second particles are densely arranged by the action of the pretreatment liquid described below.

In the ink set according to the embodiment, since the second particles are flocculated by the action of the pretreatment liquid imparted onto the recording medium, the second particles are hardly flocculated before being subjected to the action of the pretreatment liquid. That is, since the second particles before the flocculation are provided with a property of being porous, it is possible to suppress the sedimentation and since the particle size of the second particles before the flocculation is smaller compared to that of the second particles after the flocculation, discharge properties are excellent when being discharged from a nozzle of an ink jet recording apparatus. On the other hand, since the second particles after the flocculation are ones in which the second particles are densely arranged on the recoding medium, the brightness of a white-based image which is recorded is extremely enhanced. In addition, by the second particles being densely arranged on the recording medium, it is possible to reduce a blur of the white-based image which is recorded. In this manner, in the ink set according to the embodiment, the sedimentation properties and the discharge stability of the white-based color material are improved and it is possible to extremely enhance the brightness the white-based image which is recorded.

### 1.1.2. Resin

A resin can enhance the physical strength of the abrasion resistance or the like of the image which is recorded. As such a resin, a well-known resin such as an acrylic-based resin, a styrene acrylic-based resin, a fluorene-based resin, an urethane-based resin, a polyolefin-based resin, a rosin-modified resin, a terpene-based resin, a polyester-based resin, a polyamide-based resin, an epoxy-based resin, a vinyl chloride-based resin, a vinyl chloride-acetate vinyl copolymer, or an ethylene vinyl acetate-based resin, polyolefin wax, and the like are included. These resins can be used as one kind alone or in combination of two or more kinds thereof.

Among these resins exemplified above, a styrene acrylic-based resin, a polyester-based resin, or polyolefin wax can be preferably used.

As a polyester-based resin, commercial products can be used and, for example, Eastek 1100, 1300, and 1400 (hereinbefore, trade names, manufactured by Eastman Chemical Japan Ltd.), Elitel KA-5034, KA-3556, KA-1449, KT-8803, KA-5071S, KZA-1449S, KT-8701, and KT9204 (hereinbefore, trade names, manufactured by UNITIKA LTD.), and the like are included.

As a styrene acrylic-based resin, for example, a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like are included. Moreover, as a form of a copolymer, any form of a random copolymer, a block copolymer, an alternating copolymer, and a graft copolymer can be used. Moreover, as a styrene acrylic-based resin, commercially available ones may be used. As a commercial product of a styrene acrylic-based resin, Joncryl 62J (manufactured by BASF Japan Ltd.) and the like are included.

Polyolefin wax is not particularly limited and, for example, wax manufactured from olefin such as ethylene, propylene, or butylene or a derivative thereof, and a copolymer thereof, and specifically, polyethylene-based wax, polypropylene-based wax, polybutylene-based wax, and the like are included. Among those, polyethylene-based wax is preferable from the viewpoint of being able to reduce the occurrence of cracks of the image. Polyolefin wax can be used as one kind alone or in combination of two or more kinds thereof.

As a commercial product of polyolefin wax, CHEMIPEARL series such as “CHEMIPEARL W4005” (manufactured by Mitsui Chemicals, Inc., polyethylene-based wax, the particle size from 200 nm to 800 nm, the ring and ball softening point of 100° C., the penetration method hardness of 3, and the solid content of 40%) are included. In addition, AQUACER series such as AQUACER 513 (polyethylene-based wax, the particle size from 100 nm to 200 nm, the melting point of 130° C., the solid content of 30%), AQUACER 507, AQUACER 515, and AQUACER 840 (hereinbefore, manufactured by BYK Japan KK), HYTEC series such as HYTEC E-7025P, HYTEC E-2213, HYTEC E-9460, HYTEC E-9015, HYTEC E-4A, HYTEC E-5403P, and HYTEC E-8237 (hereinbefore, manufactured by TOHO Chemical Industry Co., Ltd.), NOPCOTE PEM-17 (manufactured by SAN NOPCO LIMITED, polyethylene emulsion, the particle size of 40 nm), and the like are included. These are commercially available in a form of a water-based emulsion in which polyolefin wax is dispersed in water according to the general method.

In a case of containing the resin, the content (in terms of a solid content) is preferably from 1% by mass to 10% by mass and more preferably from 1% by mass to 7% by mass, with respect to the total mass of the white-based ink composition.

The content of the white-based color material is preferably from 0.2 times to 20 times and more preferably from 1 time to 10 times, in terms of a solid content, with respect to the content of the resin described above. Since fixing properties of the white-based color material to the recording medium become excellent owing to the content of the white-based color material being within the range described above, the abrasion resistance of the obtained white-based image is enhanced.

As to the resin, it is preferable to being an emulsion from the viewpoint of being able to enhance the abrasion resistance and the adhesion of a film, the storage stability of an ink, or the like. The resin included in the white-based ink according to the embodiment may be a self-emulsification type resin in which a hydrophilic component required to stably disperse in water is introduced or may be one which has the water-dispersibility by using an external emulsifier, however, a self-emulsification type dispersion (a self-emulsification type emulsion) which does not include an emulsifier is preferable from the viewpoint of not inhibiting a reaction with the flocculant included in the pretreatment liquid described below.

### 1.1.3. Solvent

The white-based ink composition can contain at least one of water and an organic solvent (described below) as a solvent. In a case where the white-based ink composition contains water as a solvent, the white-based ink composition is used as a so-called water-based ink. On the other hand, in a case where the white-based ink composition does not substantively contain water, the white-based ink composition is used as a so-called non-water-based ink.

In the invention, “does not substantively include A” simply means that A is not purposely added when an ink is manufactured or simply means that A is not added exceeding the amount in which a purpose of adding A is sufficiently achieved. A specific example of “not substantively included” is, for example, not to include 1.0% by mass or more, preferably not to include 0.5% by mass or more, more preferably not to include 0.1% by mass or more, further more preferably not to include 0.05% by mass or more, particularly preferably not to include 0.01% by mass, and most preferably not to include 0.001% by mass or more.

In a case where water is contained, it is preferable to use pure water such as ion-exchanged water, ultrafiltration water, reverse osmotic water, or distilled water or one in which ionic impurities are removed as much as possible like ultrapure water. In addition, when water which is sterilized by irradiating with an ultraviolet ray, adding hydrogen peroxide, or the like is used, in a case of storing a pigment dispersion liquid and an ink using this for a long period, it is possible to prevent the generation of mold or bacteria.

In a case where the white-based ink composition is a water-based ink, for example, the content of water can be set to 50% by mass or more with respect to the total mass of the white-based ink composition.

### 1.1.4. Organic Solvent

The white-based ink composition may contain an organic solvent. The white-based ink composition may contain plural kinds of organic solvents. The organic solvent is not particularly limited, however, for example, 1,2-alkane diols, polyalcohols, a pyrrolidone derivative, lactone, glycol ethers, and the like are included.

As 1,2-alkane diols, for example, 1,2-propanediol, 1,2-butanediol, 1,2-pentanedial, 1,2-hexanediol, 1,2-octanediol, and the like are included. Since 1,2-alkane diols are excellent in action of uniformly wetting by enhancing the wettability of ink to the recording medium, there are some cases where it is possible to form the image excellent in adhesion on the recording medium. In a case where 1,2-alkane diols are contained, the content thereof can be set from 1% by mass to 20% by mass with respect to the total mass of the white-based ink composition.

As polyalcohols, for example, ethylene glycol, diethylene glycol, propylene glycol, dipropylene glycol, 1,3-propanediol, 1,4-butanediol, 1,6-hexanediol, trimethylolpropane, glycerine, and the like are included. The polyalcohols can preferably be used on a nozzle forming surface of a recording head of an ink jet recording apparatus from the viewpoint of being able to reducing clogging, the discharge failure, or the like by suppressing the drying and solidification of an ink. In a case where the polyalcohols are contained, the content thereof can be set from 2% by mass to 20% by mass with respect to the total mass of the white-based ink composition.

As a pyrrolidone derivative, for example, N-methyl-2-pyrrolidone, N-ethyl-2-pyrrolidone, N-vinyl-2-pyrrolidone, 2-pyrrolidone, N-butyl-2-pyrrolidone, 5-methyl-2-pyrrolidone, and the like are included. The pyrrolidone derivative can act as an excellent dissolving agent of a resin component. In a case where the pyrrolidone derivative is contained, the content thereof can be set from 0.5% by mass to 10% by mass with respect to the total mass of the white-based ink composition.

In the invention, “lactone” is collectively called a cyclic compound having an ester group (—CO—O—) in a ring. Lactone is not particularly limited as long as lactone is one included in the definition described above, however, lactone having from 2 to 9 carbon atoms is preferable. As a specific example of such lactone, α-ethyllactone, α-acetolactone, β-propiolactone, γ-butyrolactone, δ-valerolactone, ε-caprolactone, ζ-enantiolactone, η-caprylolactone, γ-valerolactone, γ-heptalactone, γ-nonalactone, β-methyl-δ-valerolactone, 2-butyl-2-ethylpropiolactone, α,α-diethylpropiolactone, and the like are included, however, among those, γ-butyrolactone is particularly preferable. In a case where the recording medium is a film such as a vinyl chloride resin, lactone enhances the adhesion by penetrating the ink inside the recording medium. In particular, lactone is preferably used in a case where the white-based ink composition is a non-water-based ink and the content in this case can be set from 5% by mass to 30% by mass with respect to the total mass of the white-based ink composition.

As glycol ethers, for example, ethylene glycol monoisobutyl ether, ethylene glycol monohexyl ether, ethylene glycol monoisohexyl ether, diethylene glycol monohexyl ether, triethylene glycol monohexyl ether, diethylene glycol monoisohexyl ether, triethylene glycol monoisohexyl ether, ethylene glycol monoisoheptyl ether, diethylene glycol monoisoheptyl ether, triethylene glycol monoisoheptyl ether, ethylene glycol monooctyl ether, ethylene glycol monoisooctyl ether, diethylene glycol monoisooctyl ether, triethylene glycol monoisooctyl ether, ethylene glycol mono-2-ethylhexyl ether, diethylene glycol mono-2-ethylhexyl ether, triethylene glycol mono-2-ethylhexyl ether, diethylene glycol mono-2-ethylpentyl ether, ethylene glycol mono-2-ethylpentyl ether, ethylene glycol mono-2-ethylhexyl ether, diethylene glycol mono-2-ethylhexyl ether, ethylene glycol mono-2-methylpentyl ether, diethylene glycol mono-2-methylpentyl ether, propylene glycol monobutyl ether, dipropylene glycol monobutyl ether, tripropylene glycol monobutyl ether, propylene glycol monopropyl ether, dipropylene glycol monopropyl ether, tripropylene glycol monomethyl ether, and the like are included. These can be used as one kind alone or by mixing two or more kinds thereof. The glycol ethers can control the wettability to the recording medium or the penetration speed of ink. Therefore, it is possible to record a vivid image having less shade unevenness. In a case where the white-based ink composition is used as a water-based ink, when the glycol ethers are contained, the content thereof can be set to from 0.05% by mass to 6% by mass with respect to the total mass of the white-based ink composition. On the other hand, in a case where the white-based ink composition is used as a non-water-based ink, the content thereof can be set to from 70% by mass to 90% by mass with respect to the total mass of the white-based ink composition.

### 1.1.5. Surfactant

The white-based ink composition may contain a surfactant. The surfactant is provided with a function of enhancing the wettability to the recording medium by reducing the surface tension. Among these surfactants, for example, an acetylene glycol-based surfactant, a silicone-based surfactant, and a fluorine-based surfactant can be preferably used.

The acetylene glycol-based surfactant is not particularly limited, however, for example, Surfynol 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (hereinbefore, all trade names, manufactured by Air Products and Chemicals. Inc.), Olfine B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (hereinbefore, all trade names, manufactured by Nissin Chemical Co., Ltd.), and Acetylenol E00, E00P, E40, and E100 (hereinbefore, all trade names, manufactured by Kawaken Fine Chemicals Co., Ltd.) are included.

The silicone-based surfactant is not particularly limited, however, polysiloxane-based compound is preferably included. The polysiloxane-based compound is not particularly limited, however, for example, polyether-modified organosiloxane is included. As a commercial product of the polyether-modified organosiloxane, for example, BYK-306, BYK-307, BYK-333, BYK-341, BYK-345, BYK-346, and BYK-348 (hereinbefore, trade names, manufactured by BYK Japan KK) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (hereinbefore, trade names, manufactured by Shin-Etsu Chemical Co., Ltd.) are included.

As a fluorine-based surfactant, it is preferable to use a fluorine-modified polymer and as a specific example, BYK-340 (manufactured by BYK Japan KK) is included.

In a case of containing the surfactant, the content thereof is preferably 0.1% by mass to 1.5% by mass with respect to the total mass of the white-based ink composition.

### 1.1.6. Other Component

The white-based ink composition may include a thickener, a polymerizable compound, a pH adjuster, an antiseptic agent and an anti-mold agent, a rust inhibitor, a chelating agent, and the like may be contained as necessary.

### Thickener

The thickener can be used for adjusting the viscosity of ink. As a thickener, for example, polyvinyl alcohols, poly(meth)acrylic acids, polyethers, polyvinyl pyrrolidones, polyvinyl formals, protein (for example, gelatin, casein, glue, or the like), polysaccharides (for example, pullulan, dextran, dextrin, cyclodextrin, carrageenan, pectin, glucomannan, sodium alginate, xanthan gum, gum arabic, locust bean gum, tragacanth gum, guar gum, tamarind gum, or the like), starches (for example, starch, oxidized starch, carboxyl starch, dialdehyde starch, or the like), cellulose or a derivative thereof (for example, methyl cellulose, ethyl cellulose, carboxymethyl cellulose, hydroxyethyl cellulose, hydroxypropyl cellulose, hydroxypropyl methylcellulose, or the like), an alginic acid salt (for example, sodium alginate, potassium alginate, ammonium alginate, or the like), an alginic acid ester (for example, alginic acid propylene glycol ester, or the like), and the like are included.

In a case of containing the thickener, the content thereof can appropriately be set in accordance with the viscosity of the white-based ink composition, however, for example, can be set from 1% by mass to 10% by mass with respect to the total mass of the white-based ink composition.

### Polymerizable Compound

The white-based ink composition according to the embodiment can be used as a so-called ultraviolet ray curable type ink composition which is cured by irradiating with an ultraviolet ray. In this case, it is preferable that the white-based ink composition contain the polymerizable compound. The polymerizable compound is collectively called a monomer which is polymerized by adding energy such as light, heat, or the like. Specifically, the polymerizable compound starts to be polymerized by a radical generated from a radical generator by irradiating with light or heating in the presence of the radical generator.

As a polymerizable compound, for example, various kinds of (meth)acrylates such as monofunctional(meth)acrylate (for example, phenoxyethyl(meth)acrylate, or the like), bifunctional(meth)acrylate (for example, diethylene glycol di(meth)acrylate or the like), polyfunctional(meth)acrylate having three or more functions (for example, trimethylolpropane tri(meth)acrylate, pentaerythritol ethoxy tetra(meth)acrylate, or the like) are included. As a radical generator, a photopolymerization initiator such as acetophenone or acyl phosphine oxide, a thermal polymerization initiator such as tert-butyl peracetate, and the like are included.

It is suitable to use the white-based color material included in the white-based ink composition according to the embodiment for the ultraviolet ray curable type ink composition, compared to hollow resin particles. That is, this is because that the hollow resin particles are a type of white-based color material, however, in a case where the hollow resin particles are applied to the ultraviolet ray curable type ink composition including the polymerizable compound, the polymerizable compound entering inside a cavity of the hollow resin particles, and thus the brightness is extremely reduced.

### pH Adjuster

As a pH adjuster, for example, potassium dihydrogen phosphate, disodium hydrogen phosphate, sodium hydroxide, lithium hydroxide, potassium hydroxide, ammonia, diethanolamine, triethanolamine, triisopropanolamine, potassium carbonate, sodium carbonate, sodium hydrogen carbonate, and the like are included.

### Antiseptic Agent and Anti-Mold Agent

As an antiseptic agent and an anti-mold agent, for example, sodium benzoate, sodium pentachlorophenol, 2-pyridinethiol-1-oxide sodium, sodium sorbate, sodium dehydroacetate, 1,2-dibenzothiazolin-3-one, and the like are included. As a commercial product, Proxel XL2 and Proxel GXL (hereinbefore, trade names, manufactured by Avecia Ltd.), Denicide CSA and NS-500W (hereinbefore, trade names, manufactured by Nagase ChemteX Corporation), and the like are included.

### Rust Inhibitor

As a rust inhibitor, for example, benzotriazole and the like are included.

### Chelating Agent

As a chelating agent, for example, ethylenediaminetetraacetic acid and a salt thereof (disodium dihydrogen ethylenediamine tetraacetate or the like), and the like are included.

### 1.1.7. Method of Manufacturing White-Based Ink Composition

The white-based ink composition according to the embodiment can be obtained by respectively mixing the components (materials) described above in an arbitrary order and removing the impurities by performing the filtration or the like as necessary. Here, in a case where a pigment is added, it is preferable to mix the pigment after the pigment is prepared to a state of uniformly dispersing in a solvent in advance, due to becoming simple in handling. As a method of mixing each material, a method of stirring and mixing by sequentially adding the materials into a container provided with a stirring apparatus such as a mechanical stirrer or a magnetic stirrer is suitably used. As a method of filtering, for example, a centrifugal filtration, a filter filtration, and the like can be performed as necessary.

### 1.1.8. Physical Property of White-Based Ink Composition

As to the white-based ink composition according to the embodiment, the surface tension at 20° C. is preferably from 20 mN/m to 40 mN/m and more preferably from 25 mN/m to 35 mN/m, from the viewpoint of the balance between the image quality and the reliability as an ink in a case of applying to an ink jet recording apparatus. Moreover, as to the measurement of the surface tension, for example, it is possible to measure by confirming the surface tension when a platinum plate is wet by the ink under an environment at 20° C. using an automatic surface tension device CBVP-Z (trade name, manufactured by Kyowa Interface Science Co., Ltd.)

In addition, from the viewpoint of the same, the viscosity at 20° C. of the white-based ink composition according to the embodiment is preferably from 3 mPa·s to 10 mPa·s and more preferably from 3 mPa·s to 8 mPa·s. Moreover, as the measurement of the viscosity, for example, the viscosity can be measured under an environment at 20° C. using a viscoelasticity testing machine MCR-300 (trade name, manufactured by Physica).

### 1.2. Pretreatment Liquid

### 1.2.1. Flocculant

The pretreatment liquid according to the embodiment contains a flocculant. The flocculant has a function of aggregating the white-based color material by reacting with the white-based color material included in the white-based ink composition or the resin which can be included in the white-based ink composition. Thereby, it is possible to enhance the brightness of the white-based image formed by the white-based ink composition or suppress the occurrence of a blur.

The flocculant is not particularly limited, however, an organic acid (for example, acetic acid, propionic acid, lactic acid, or the like or a salt thereof), polyallylamine, a polyallylamine derivative, a polyvalent metal compound, and the like are included, and among those, a polyvalent metal compound and an organic acid can be preferably used and a polyvalent metal compound can be more preferably used, in terms of being more excellent in flocculation action of the white-based color material described above.

The polyvalent metal compound is not limited to the following, however, for example, a titanium compound, a chromium compound, a copper compound, a cobalt compound, a strontium compound, a barium compound, an iron compound, an aluminum compound, a calcium compound, and a magnesium compound and a salt thereof (a polyvalent metal salt) are included. Among those polyvalent metal compounds, since it is possible to effectively flocculate a pigment, one kind or more selected from a group consisting of an aluminum compound, a calcium compound, and a magnesium compound and a salt thereof are preferable, a dissociable salt of an alkaline earth metal such as calcium or magnesium is more preferable, at least any of a calcium salt and a magnesium salt is further preferable, and a calcium salt is further more preferable. Moreover, as to a polyvalent metal compound, an ionic polyvalent metal compound is preferable.

In particular, in a case where the polyvalent metal compound is a calcium salt, the stability of the pretreatment liquid becomes more excellent and in a case where the recording medium (particularly the fabric) after the pretreatment is heat-pressed, the polyvalent metal compound (the calcium salt) becomes difficult to be deposited on the surface of the recording medium.

As a specific example of the polyvalent metal compound, calcium carbonate such as heavy calcium carbonate and precipitated calcium carbonate, an inorganic pigment such as chalk, kaolin, calcined clay, talc, calcium nitrate, calcium chloride, calcium sulfate, magnesium sulfate, barium sulfate, titanium oxide, zinc oxide, zinc sulfide, zinc carbonate, aluminum silicate, calcium silicate, magnesium silicate, synthetic silica, aluminum hydroxide, alumina, sericite, white carbon, saponite, calcium montmorillonite, sodium montmorillonite, and bentonite and an organic pigment such as an acrylic-based plastic pigment and a urea polymer substance are included. Among those, since it is possible to ensure the sufficient solubility in water and reduce marks left (the marks become inconspicuous) of the pretreatment, at least any of calcium nitrate and calcium chloride is preferable and calcium nitrate is more preferable.

In a case where the polyvalent metal compound is used as a flocculant, the content of a metal ion included in the polyvalent metal compound, that is, the concentration of a metal ion derived from the polyvalent metal compound is preferably from 0.5% by mass to 5% by mass and more preferably from 1% by mass to 5% by mass, with respect to the total mass of the pretreatment liquid (100% by mass). When the concentration is within the range described above, the white-based color material (the second particles) is sufficiently flocculated and the marks of pretreatment liquid become inconspicuous.

### 1.2.2. Resin

The pretreatment liquid according to the embodiment may contain a resin. Thereby, since the fixation of the pretreatment liquid to the recording medium is enhanced, the abrasion resistance of the white-based image which is recorded becomes excellent. In addition, it is preferable to add the resin in a form of emulsion. As to a resin emulsion, it becomes possible to suppress an increase in viscosity of the pretreatment liquid even in a case of adding the same solid content concentration, compared to a case of using a solution type resin. As a specific example of the resin, since it is possible to use the same one as the resin which is exemplified in the description of the white-based ink composition, the description thereof will be omitted.

In a case where the resin is contained, the content thereof is preferably from 1% by mass to 20% by mass, more preferably from 1% by mass to 16% by mass, and further more preferably from 3% by mass to 16% by mass, in terms of a solid content, with respect to the total mass of the pretreatment liquid. When the content of the resin is within the range described above, it is possible to make the abrasion resistance of the white-based image which is obtained more excellent.

### 1.3.3. Other Components

The pretreatment liquid may contain a component other than the above. As such a component, for example, a surfactant, water, a thickener, an organic solvent, a pH adjuster, an antiseptic agent and an anti-mold agent, a rust inhibitor, a chelating agent, and the like are included.

As a surfactant, since it is possible to use the same one as the surfactant which is exemplified in the description of the white-based ink composition, the description thereof will be omitted. In a case of containing the surfactant, the content thereof is not particularly limited, however, for example, the content can be set to from 0.05% by mass to 0.5% by mass with respect to the total mass of the pretreatment liquid.

Water is a principal medium of the pretreatment liquid and is a component which is evaporated and scattered by drying. As water, it is possible to use the same one as water which is exemplified in the description of the white-based ink composition. The content of water is not particularly limited, however, for example, the content can be set to 50% by mass or more with respect to the total mass of the pretreatment liquid.

As a thickener, since it is possible to use the same one as the thickener which is exemplified in the description of the white-based ink composition, the description thereof will be omitted. In a case of containing the thickener, the content thereof is not particularly limited, however, for example, the content can be set to 20% by mass or less with respect to the total mass of the pretreatment liquid.

As an organic solvent, a pH adjuster, an antiseptic agent and an anti-mold agent, a rust inhibitor, and a chelating agent, since it is possible to use the same ones as the the organic solvent, the pH adjuster, the antiseptic agent and the anti-mold agent, a rust inhibitor, and the chelating agent which is exemplified in the description of the white-based ink composition, the description thereof will be omitted.

### 1.3.4. Method of Manufacturing Pretreatment Liquid

The pretreatment liquid according to the embodiment can be obtained by respectively mixing the components (materials) described above in an arbitrary order and removing the impurities by performing the filtration or the like as necessary. As a method of mixing each material, a method of stirring and mixing by sequentially adding the materials into a container provided with a stirring apparatus such as a mechanical stirrer or a magnetic stirrer is suitably used. As a method of filtering, for example, a centrifugal filtration, a filter filtration, and the like can be performed as necessary.

### 1.3.5. Physical Property of Pretreatment Liquid

The viscosity at 20° C. of the pretreatment liquid according to the embodiment is preferably from 30 mPa·s or lower, more preferably 25 mPa·s or lower, further more preferably 20 mPa·s or lower, particularly preferably 15 mPa·s or lower, more particularly preferably 10 mPa·s or lower, and most particularly preferably 5 mPa·s or lower, from the viewpoint of enhancing discharge properties from a nozzle in a case of using an ink jet method or a spray method or enhancing application properties in a case of using a roll coater or the like. The lower limit is not limited, however, it is preferable to be 1 mPa·s or higher. Moreover, as the measurement of the viscosity, for example, the viscosity can be measured under an environment at 20° C. using a viscoelasticity testing machine MCR-300 (trade name, manufactured by Physica).

### 2. Method of Recording

A method of recording according to the invention uses the ink set described above (the set of a white-based ink composition and a pretreatment liquid). The method of recording according to the embodiment of the invention includes a process of adhering the pretreatment liquid onto the recording medium and a process of adhering the white-based ink composition onto a region in which the pretreatment liquid is adhered. In the method of recording according to the embodiment, it is possible to improve the sedimentation properties of the white-based ink composition and obtain the white-based image having high brightness. In particular, in a case where the process of adhering the white-based ink composition onto the recording medium is performed by an ink jet recording apparatus, since the particle size of the white-based color material which is discharged from a nozzle is sufficiently small, the method of recording becomes excellent in discharge stability.

Hereinafter, description will be given of a method of recording according to the embodiment for each process.

### 2.1. Process of Adhering Pretreatment Liquid

The method of recording according to the embodiment includes a process of adhering the pretreatment liquid described above onto the recording medium (hereinafter, also referred to as “an adhering process of the pretreatment liquid”).

As a method of adhering the pretreatment liquid, for example, a method of dipping the recording medium into the pretreatment liquid, a method of applying the pretreatment liquid by a roll coater or the like, a method of jetting the pretreatment liquid, and the like are included and any method can be used. The jetting of the pretreatment liquid can be performed using a jetting apparatus in which a spray system, an ink jet system, or the like is employed and in any case, the jetting is contactlessly performed with respect to the recording medium.

The adhesion amount of the pretreatment liquid is preferably from 0.1 mg/cm² to 30.0 mg/cm² and more preferably from 0.4 mg/cm² to 10 mg/cm². When the adhesion amount is 0.4 mg/cm² or more, it becomes easier to further aggregate the white-based color material (the second particles). In addition, when the adhesion amount is 10 mg/cm² or less, it is possible to shorten the drying time for the pretreatment liquid, and thus the high-speed of recording can be achieved.

A process of drying the pretreatment liquid may be provided after the adhering process of the pretreatment liquid and before the adhering process of the white-based ink composition. In this case, it is preferable that the drying be halted in a state in which the pretreatment liquid is wet. The drying process of the pretreatment liquid may be performed with natural dry, however, may be the drying with heat from the viewpoint of enhancing the drying speed or promoting the fusion of a resin component included in the pretreatment liquid to a fabric. In a case where the drying process of the pretreatment liquid is performed with heating, the method of heating is not particularly limited, however, for example, a heat press method, an atmospheric steam method, a high-pressure steam method, and a thermo fix method are included. In addition, as a heat resource of heating, for example, an infrared ray (lamp) is included.

As a recording medium, any kind of recording mediums such as plain paper, coat paper, a plastic film, a fabric, or leather can be used. Among these recording mediums, in a case of using an ink-non-absorbing recording medium such as a plastic film, since the first particles which are separated from the second particles become hard to enter inside the recording medium and remain on the surface of the recording medium, the first particles contribute to enhancing the brightness of the white-based image.

The ink-non-absorbing recording medium is not limited to the following, however, for example, one in which the plastic is coated and one in which the plastic film is bonded on a substrate such as a plastic film which is not subjected to a surface treatment (that is, an ink absorbing layer is not formed) and paper are included. The plastic is not particularly limited, however, for example, polyvinyl chloride, polyethylene terephthalate, polycarbonate, polystyrene, polyurethane, polyethylene, and polypropylene are included.

Moreover, in the specification, “an ink-non-absorbing recording medium” indicates “a recording medium in which the amount of water absorption from the start of contact to 30 msec^{1/2} is 10 mL/m² or less in the Bristow method”. The Bristow method is the most common method as a measurement method of the amount of liquid absorption for a short time and is also employed in the Japan Technical Association of the Pulp and Paper Industry (JAPAN TAPPI). The details of a testing method are described in the standard No. 51 of “Paper and Paperboard-Liquid Absorption Testing Method-Bristow method” in the “JAPAN TAPPI Paper and Pulp Testing Method in the 2000 edition”.

### 2.2. Adhering Process of White-Based Ink Composition

The method of recording according to the embodiment includes a process of adhering the white-based ink composition described above in a region onto which the pretreatment liquid is adhered. Thereby, since the flocculant reacts with the second particles on the recording medium to flocculate the second particles, the image excellent in brightness is obtained.

It is preferable that the white-based ink composition be adhered onto the region of the recording medium onto which the pretreatment liquid is imparted so that the white-based color material is 0.1 mg/cm² or more and it is more preferable that the white-based ink composition be adhered so that the white-based color material is from 0.3 mg/cm² to 30.0 mg/cm². When the adhesion amount of the white-based color material is set to be within the range described above, it is possible to enhance the brightness or concealing properties of the white-based image which is obtained. In addition, even if the adhesion amount of the white-based color material exceeds 30.0 mg/cm², since there is a tendency in which an enhancement of the brightness is not recognized, it is preferable that the adhesion amount of the white-based color material be set to 30.0 mg/cm² or less from the viewpoint of saving an ink.

It is preferable that the adhesion amount (mg/cm²) of the white-based color material be from 0.2 times to 20 times and it is more preferable that the adhesion amount be from 1 time to 10 times, in the region on the recording medium onto which the pretreatment liquid is imparted, with respect to the adhesion amount (mg/cm²) of the flocculant. When the adhesion amount is within the range described above, the balance of the adhesion amount between the white-based color material and the flocculant becomes excellent, and thus it becomes easier to obtain the white-based image having excellent brightness and less blurring.

In the adhering process of the white-based ink composition, it is preferable that the adhesion of the white-based ink composition be performed in a state in which the pretreatment liquid on the recording medium is wet. In doing so, since it is possible to make the reactivity between the flocculant included in the pretreatment liquid and the second particles included in the white-based ink composition excellent, it becomes easier to proceed the flocculation of the second particles. Here, the state in which the pretreatment liquid is wet means a state in which 30% by mass or more (preferably from 30% by mass to 80% by mass and more preferably from 40% by mass to 70% by mass) of a liquid medium remains in a case where a liquid medium included in the pretreatment liquid is set to 100% by mass when the white-based ink composition is adhered onto the recording medium. When the liquid medium is set to 80% by mass or less, it is possible to suppress over-mixing the white-based ink composition with the pretreatment liquid, and thus it is possible to suppress generating a blur of the white-based image or the like.

After the adhering process of the white-based ink composition, a process of drying the white-based ink composition may be provided. The drying of the white-based ink composition may be performed with natural dry, however, it is preferable that the drying be performed with heat from the viewpoint of enhancing the drying speed or promoting the film formation of a resin component or the like included in an ink. In a case where the drying process of the white-based ink composition is performed with heat, the method of heating is not particularly limited, however, the method exemplified in the drying process of the pretreatment liquid described above can be used.

In a case of using a fabric as a recording medium, after the drying process of the white-based ink composition, a process of water-washing a printed matter and then drying may be performed. At that time, a soaping treatment, that is, a treatment of washing out a pigment which is not fixed by a thermal soap or the like may be performed as necessary. Thereby, there are some cases where color developing properties of the white-based image or the like is enhanced.

### 2.3. Ink Jet Recording Apparatus

A method of adhering the white-based ink composition can be performed using, for example, an ink jet recording apparatus. Hereinafter, description will be given of an example of an ink jet recording apparatus capable of recording the white-based image using the white-based ink composition with reference to drawings. In drawings used in the following description, in order to make each member to a recognizable size, the reduction scale of each member is appropriately changed. In the embodiment, an ink jet printer (hereinafter, simply referred to as “a printer”) is exemplified as an ink jet recording apparatus.

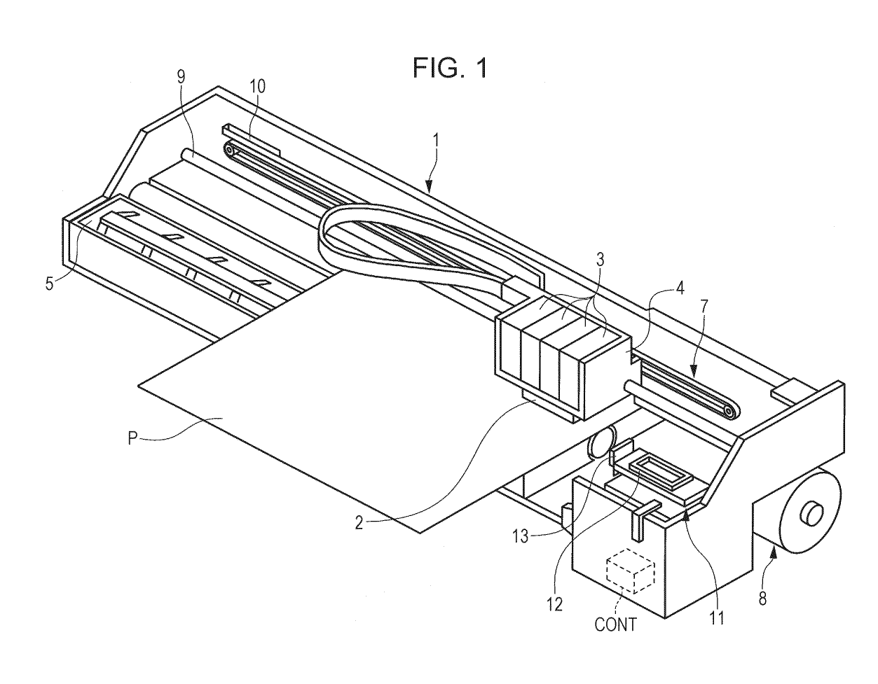

FIG. 1 is a perspective view showing a configuration of a printer 1 in the embodiment. The printer 1 shown in FIG. 1 is a serial printer. The serial printer is one in which a head is mounted on a carriage which is moved in the predetermined direction and liquid droplets are discharged onto the recording medium by moving the head in accordance with the movement of the carriage. Moreover, in FIG. 1, the serial printer is exemplified, however, the ink jet recording apparatus is not limited thereto and a line printer may be used as an ink jet recording apparatus. The line printer is one in which the width of the head is formed wider than that of the recording medium and liquid droplets are discharged with respect to the recording medium without moving the head.

As shown in FIG. 1, the printer 1 mounts a head 2 and has a carriage 4 on which an ink cartridge 3 is detachably attached, a platen 5 which is arranged under the head 2 and to which a recording medium P is transferred, a carriage moving mechanism 7 for moving the carriage 4 in a medium width direction of the recording medium P, and a medium transferring mechanism 8 for transferring the recording medium P in the medium transferring direction. In addition, the printer 1 has a control apparatus CONT for controlling the entire operation of the printer 1. Moreover, the medium width direction is a main scanning direction (a head scanning direction). The medium transferring direction is a sub-scanning direction (a direction orthogonal to the main scanning direction).

The ink cartridge 3 according to the embodiment consists of four independent cartridges. The white-based ink composition is filled in any one of four cartridges. The desired ink composition (for example, a yellow ink composition, a cyan ink composition, a magenta ink composition, a black ink composition, or the like) is filled in the cartridges other than the cartridge in which the white-based ink composition is filled. Moreover, in an example of FIG. 1, the number of the cartridges is four, however, is not limited thereto, and it is possible to mount the cartridges of the desired number. In addition, in a case where the pretreatment liquid is adhered onto the recording medium by an ink jet system, the cartridge in which the pretreatment liquid is filled is mounted on the carriage 4 and the pretreatment liquid may be able to be supplied to the head 2.

The ink cartridge 3 is not limited to one which is attached to the carriage 4 as in the embodiment and, for example, may be a type of which the ink cartridge is attached on a housing side of the printer 1 to supply the pretreatment liquid to the head 2 through an ink supply tube.

The carriage 4 is one installed in a state of being supported by a guide rod 9 erected as a support member in the main scanning direction. In addition, the carriage 4 is moved in the main scanning direction along the guide rod 9 by the carriage moving mechanism 7. Moreover, in an example of FIG. 1, an example in which the carriage 4 is moved in the main scanning direction is shown, however, the carriage 4 is not limited thereto and may be one which is moved in the sub-scanning direction in addition to the movement of the main scanning direction.

A linear encoder 10 is one which detects a position of the carriage 4 in the main scanning direction as a signal. The detected signal is sent to the control apparatus CONT as position information. The control apparatus CONT recognizes a scanning position of the head 2 based on position information from this linear encoder 10 and controls a recording operation (a discharging operation) or the like by the head 2. In addition, the control apparatus CONT has a configuration in which the moving speed of the carriage 4 can be variably controlled.

As a ink jet recoding system of the head 2, an electrostatic suction system, a system of jetting ink droplets by a pump pressure, a system using a piezoelectric element, a system of jetting ink droplets by heating and foaming an ink liquid by a microelectrode, and the like are included. Among those, a system using a piezoelectric element can be preferably used.

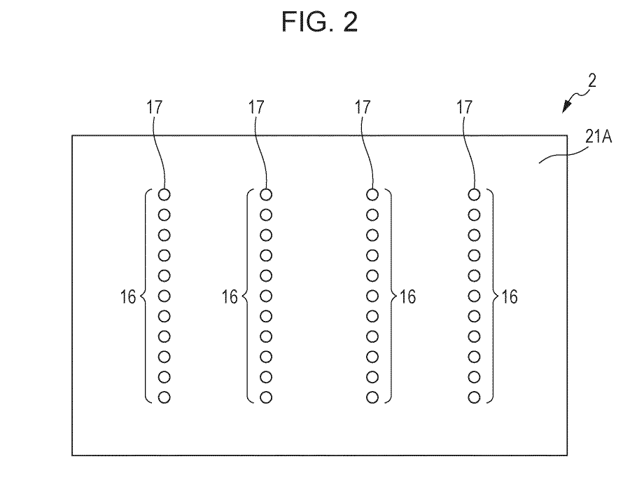

FIG. 2 is a schematic view showing a nozzle forming surface 21A in a head 2 according to the embodiment. As shown in FIG. 2, the head 2 is provided with the nozzle forming surface 21A. A plurality of nozzle rows 16 are arrayed on the nozzle forming surface 21A which is also a discharge surface of the ink. A plurality of nozzle rows 16 consist of a plurality of nozzle holes 17 for discharging the ink by each nozzle row.

A liquid repellent film is provided on the surface of the nozzle forming surface 21A. The liquid repellent film in not particularly limited and, for example, a silane coupling agent (SCA) film and one described in Japanese Patent No. 4424954 can be used. Moreover, in particular, one having water-repellency is also referred to as a water-repellent film.

It is preferable that the diameter of the nozzle hole 17 be from 15 μm to 30 μm. In this manner, even if the diameter of the nozzle hole 17 is small, the particle size of the white-based color material (the second particles before the flocculation) included in the white-based ink composition is sufficiently small, and thus the discharge stability becomes excellent.

Returning to FIG. 1, a home position which becomes a scanning point of the head 2 is set in a region outside the platen 5 in a movement range of the head 2. A maintenance unit 11 including a cap member 12 and a wiping member 13 is provided at this home position.

The maintenance unit 11 is configured to execute a moisturizing operation of suppressing the evaporation of ink by capping the head 2 with the cap member 12 except in the recording operation, a flushing operation of preventing the clogging of the nozzle hole 17 due to thickening of ink by preliminarily discharging the ink from each nozzle hole 17 of the head 2 to the cap member 12 and normally discharging the ink from the head 2 by adjusting meniscus of the nozzle hole 17, a suction operation (a head cleaning) of normally discharging the ink from the head 2 by driving a suction pump (not shown) and compulsory sucking the ink in which viscosity properties are increased, the adhered dust, or the like from each nozzle hole 17 to adjust meniscus after the head 2 is capped with the cap member 12, and a wiping operation of performing a purge treatment of removing the ink adhered in the vicinity of the nozzle hole 17, the ink in which the viscosity is increased, or the like or destroying meniscus of the nozzle hole 17 to readjust meniscus, by wiping the nozzle forming surface 21A (refer to FIG. 2) of the head 2 using a wipe member 13.

The wipe member 13 is an example of a wiping section in an aspect. As a wiping section, a roller-like wipe member and the like are included in addition to the blade-like wipe member 13 shown in FIG. 1. For the material of the wipe member 13, a rubber, a fabric, a sponge, a pulp, or the like can be used and among those, a fabric, a sponge, and a pulp are preferable in terms of being difficult to damage a liquid repellent layer when wiping or being excellent in retention properties of liquid.

The printer 1 may be provided with a cleaning liquid imparting section for imparting a cleaning liquid to the wipe member 13 or the nozzle forming surface 21A. The cleaning liquid imparting section may be provided at any position of the printer 1 as long as the cleaning liquid can be imparted to the wipe member 13 or the nozzle forming surface 21A. As a cleaning liquid imparting section, for example, a mechanism of dripping or spraying the cleaning liquid, a mechanism of dipping the nozzle forming surface 21A or the wipe member 13 into a container retaining the cleaning liquid, and the like are included.

As a cleaning liquid, one containing at least one kind selected from an organic solvent, water, and a surfactant can be used. The organic solvent capable of being used as a cleaning liquid is not particularly limited, however, for example, glycol ethers, polyalcohols, lactones, a pyrrolidone derivative, an organic sulfur compound, alcohols, ketones, esters, ethers, and the like are included. The surfactant capable of being used as a cleaning liquid is not particularly limited, however, for example, a silicone-based surfactant, a fluorine-based surfactant, an anionic-based surfactant, a polyoxyethylene derivative which is a nonionic surfactant, and the like are included. The cleaning liquid may further contain an antiseptic agent and an anti-mold agent, a pH adjuster, a rust inhibitor, a chelating agent, and the like.

As to the cleaning liquid, the surface tension at 20° C. is preferably from 20 mN/m to 45 mN/m, more preferably from 22.5 mN/m to 40 mN/m, and further more preferably from 22.5 mN/m to 35 mN/m, from the viewpoint of being easier to be wetted and spread when the cleaning liquid is adhered onto the nozzle forming surface and becoming easier to form a liquid film and the viewpoint of the permeability to a adhered matter which is adhered onto the nozzle forming surface. Moreover, as to the measurement of the surface tension, for example, it is possible to measure by confirming the surface tension when a platinum plate is wet by the ink under an environment at 20° C. using an automatic surface tension device CBVP-Z (trade name, manufactured by Kyowa Interface Science Co., Ltd.).

In a case where the surface of the nozzle forming surface 21A is wiped by the wipe member 13, there are some cases where the color material or the like included in the ink is adhered onto the nozzle forming surface 21A. In such a case, there are some cases where the color material adhered onto the nozzle forming surface 21A damages the liquid repellent film provided on the nozzle forming surface 21A. In particular, the color material having a large particle size (for example, 200 nm or more) easily damages the liquid repellent film, however, since the particle size of the white-based color material is sufficiently small, it is possible to suppress the damage to the liquid repellent film.

Here, when the surface of the nozzle forming surface 21A on which the white-based color material exists is wiped with the wipe member 13, there are some cases where the cleaning liquid is introduced onto the nozzle forming surface 21A. In such a case, an effect of suppressing the damage to the liquid repellent film of the white-based color material and the effect described above which is exhibited by using the cleaning liquid having the specific surface tension synergistically act, and thus it is possible to prolong the durable period of the nozzle forming surface 21A.

The printer 1 may be provided with a pressurizing section (not shown) for pressurizing the image obtained by adhering the white-based ink composition onto the recording medium. The pressurizing section may be provided at any position as long as it is possible to pressurize the image and, for example, can be provided on the downstream side in the medium transferring direction of the head 2. As a pressurizing section, a press machine, a nip roll, and the like are included. Moreover, the pressurizing section may also be one in which heating or drying can be performed with pressurizing the image.

Here, hollow resin particles which are a type of the white-based color material are not suitable to be used for a printer provided with the pressurizing section since the brightness of the image is reduced by collapsing a cavity in the interior thereof when hollow resin particles are pressurized. In contrast, it is possible to suitably use the white-based color material (the second particles) described above for a printer having the pressurizing section since there are few cases where the brightness is reduced by pressurizing.

The printer 1 may be provided with a heating mechanism (not shown) for the purpose of promoting drying properties of the image which is recorded or the film formation or the like. The heating mechanism is not particularly limited, however, for example, a print heater mechanism of heating by the recording medium P being brought into contact with a heat source, a mechanism of irradiating with an infrared ray, a microwave (an electromagnetic wave having a maximum wavelength at approximately 2,450 MHz), or the like, a dryer mechanism of blowing the hot air, or the like can be used.

### 3. Example

Hereinafter, specific description will be given of the invention according to Examples and Comparative Examples, however, the invention is not limited to these Examples.

### 3.1. Preparation of Ink

### 3.1.1. Preparation of Dispersion Liquid

As to the second particles A (porous titanium dioxide) and the second particles B (porous titanium dioxide) among the white-based color material used in Examples and Comparative Examples, ones which were manufactured as follows were used. As to the white-based color material other than the second particles A and the second particles B, a commercial product was used.

### Manufacturing of Dispersion Liquid Containing Second Particles a

Firstly, as first particles, titanium dioxide nanoparticles (trade name “MT-700B”, manufactured by TAYCA CORPORATION, the average particle size of 50 nm) were prepared and these were added into a water-based medium (a medium mixing water with hexametaphosphoric acid at 1:10) and then mixed and stirred the solution under conditions at 25° C. for 2 hours to obtain a slurry solution containing 20% by mass of titanium dioxide nanoparticles in terms of a solid content.

After 83.7 g of zirconium chloride oxide octahydrate was added to this slurry solution, a sodium hydroxide aqueous solution was slowly added thereto to adjust so that pH was from 4.0 to 4.5 and the slurry solution was continuously stirred for 2 hours. The slurry solution thus obtained was filtered and the solid content was taken out to be dried.

Next, the dried solid content was arranged in an electric furnace and the second particles (the porous titanium dioxide particles) were obtained by increasing the temperature from room temperature until a temperature of 600° C. at 5° C./minute and then calcining at 600° C. for 2 hours. Then, as to the obtained second particles, the pulverization and the dispersion treatment were performed in water using a wet type beads mill and a dispersion liquid including the second particles A having an average particle size of 200 nm was obtained.

Here, the average particle size of the second particles A is a volume average particle size measured by MICROTRAC UPA (manufactured by Nikkiso Co., Ltd.).

### Manufacturing of Dispersion Liquid Containing White-Based Color Material (Second Particles B)

The second particles B were produced in the same way except using the titanium dioxide nanoparticles (trade name “JA-1”, manufactured by TAYCA CORPORATION, the average particle size of 180 nm) as first particles in the manufacturing of the second particles A described above. In doing so, a dispersion liquid including the second particles B was obtained. When the average particle size of the second particles B was measured in the same way as that of the second particles A, the average particle size was 350 nm. In addition, when a crystal structure of the second particles B was measured in the same way as that of the second particles A, the second particles B had an anatase type crystal structure.

### 3.1.2. Preparation of Ink

Each component was mixed and stirred so as to be compositions in Table 1 to obtain the white-based ink compositions according to Examples and Comparative Examples. Among the components described in Table 1, the described ones other than the compound names are as follows. In addition, in Table 1, the contents of the color material and the resin emulation are values in terms of the solid content. In addition, the particle sizes of each color material are shown in Table 2.

Second particles A (refer to the method of manufacturing described above, porous titanium dioxide particles)

Second particles B (refer to the method of manufacturing described above, porous titanium dioxide particles)

Second particles C (trade name “SNOWTEX XL”, manufactured by NISSAN CHEMICAL INDUSTRIES, LTD., porous silica particles)

Close-packed titanium dioxide A (trade name “ST-750EC”, manufactured by Titan Kogyo, Ltd.)

Close-packed titanium dioxide B (trade name “Nano Tek Slurry”, manufactured by C.I. Kasei Co., LTD., the solid content of dispersion liquid 10%)

BYK-348 (trade name, manufactured by BYK Japan KK, silicone-based surfactant)

Resin emulsion (trade name “RESAMINE D-1060”, manufactured by Dainichiseika Color & Chemicals Mfg. Co., Ltd., the solid content 40%)

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Color | Second particles A (porous | 10 | | | 10 | | | 10 |
| Material | titanium dioxide) | | | | | | | |
| | Second particles B (porous | | 10 | | | | | |
| | titanium dioxide) | | | | | | | |
| | Second particles C (porous | | | 10 | | | | |
| | silica) | | | | | | | |
| | Close-packed titanium dioxide A | | | | | 10 | | |
| | Close-packed titanium dioxide B | | | | | | 10 | |
| Organic | 1,2-Hexanediol | 3 | 3 | 3 | 3 | 3 | 3 | 3 |
| solvent | Glycerine | 10 | 10 | 10 | 10 | 10 | 10 | 10 |
| | Trimethylolpropane | 14 | 14 | 14 | 14 | 14 | 14 | 14 |
| Surfactant | BYK-348 | 0.5 | 0.5 | 0.5 | 0.5 | 0.5 | 0.5 | 0.5 |
| Resin | Resin emulsion | 8 | 8 | 8 | 8 | 8 | 8 | 8 |
| Water | Ion-exchanged water | Residue | Residue | Residue | Residue | Residue | Residue | Residue |
| Total (% by mass) | | 100 | 100 | 100 | 100 | 100 | 100 | 100 |
| Recording | Type | Film | Film | Film | Fabric | Film | Film | Film |
| medium | Whether to apply pretreatment | Application | Application | Application | Application | Non-application | Application | Non- |
| | liquid | | | | | | | application |
| Adhesion | White-based color material | 0.3 | 0.3 | 0.3 | 1 | 0.3 | 0.3 | 0.3 |
| amount | (mg/cm²) | | | | | | | |
| | Flocculant (mg/cm²) | 0.4 | 0.4 | 0.4 | 1 | 0 | 0.4 | 0 |
| Evaluation | Sedimentation properties | A | B | A | A | C | C | A |
| result | Wiping properties | A | B | A | A | C | B | A |
| | Brightness | B | A | B | A | Non- | B | C |
| | | | | | | dischargeable | | |
| | Concealing properties | A | A | B | B | Non- | A | C |
| | | | | | | dischargeable | | |
| | Abrasion resistance | A | B | A | A | Non- | A | A |
| | | | | | | dischargeable | | |

TABLE 2

| | Average particle | Average particle |
|---|---|---|
| | size of first | size of second |
| | particles (nm) | particles (nm) |
| Second particles A (porous | 50 | 200 |
| titanium dioxide) | | |
| Second particles B (porous | 80 | 300 |
| titanium dioxide) | | |
| Second particles C (porous silica) | 60 | 200 |
| Close-packed titanium dioxide A | — | 1000 |
| Close-packed titanium dioxide B | — | 300 |

### 3.3. Evaluation Test

### 3.3.1. Sedimentation Properties

After each white-based ink composition which was obtained as described above was left for 1 week in a thermostatic chamber at 20° C. and 4 g of a supernatant liquid thereof was precisely weighted, the supernatant liquid was diluted using a 1 L measuring flask. Furthermore, this diluted liquid was measured and taken out by a 5 mL whole pipette to be diluted using a 100 mL measuring flask. The absorbance WA of this liquid and the absorbance W0 when the ink composition before being left was diluted in the same way were measured at the wavelength of 500 nm and the sedimentation rate S was calculated by the following calculation formula.

The sedimentation rate S(%)=[1−(the absorbance WA)/(the absorbance W0)]×100

Then, as to the calculated sedimentation rate S (%), the sedimentation properties were evaluated based on the following evaluation criteria.

A: less than 10%
B: 10% or more and less than 30%
C: 30% or more

### 3.3.2. Wiping Properties

The white-based ink compositions of Examples and Comparative Examples which were obtained as described above were mounted on an ink jet printer (trade name “PX-W8000”, manufactured by Seiko Epson Corporation, the diameter of a nozzle of a head 20 μm). Then, after a recoding operation of discharging the white-based ink composition from all nozzles was performed, the wiping was performed on the nozzle forming surface. Moreover, in the recording operation, the wiping was performed for one pass under conditions of the resolution of 720 dpi×720 dpi and duty of 100% and the evaluation was performed in a laboratory under a condition of room temperature (25° C.). The evaluation criteria are as follows and the evaluation criteria were set based on the fact that the discharge failure of the nozzle occurs when the liquid repellent film of the nozzle forming surface is damaged by wiping.

A: It is possible to stably discharge the composition from all nozzles even if the wiping is performed 1,000 times.
B: There are 5 nozzles or less in which the discharge is not stable even if the wiping is performed 1,000 times.
C: There are 6 nozzles or more in which the discharge is not stable even if the wiping is performed 1,000 times.

### 3.3.3. Brightness

The white-based ink compositions of Examples and Comparative Examples which were obtained as described above were mounted on an ink jet printer (trade name “PX-G930”, manufactured by Seiko Epson Corporation). Then, the image consisting of the white-based ink composition was formed on the recording medium. As a printing pattern of the image, a paint-out pattern capable of being printed with the resolution of the horizontal 720 dpi and the vertical 720 dpi and duty of 100% was formed. Moreover, as a recording medium, a film (trade name “CLEARPROOF FILM”, manufactured by Seiko Epson Corporation, cut to A4 size) or a fabric (trade name “HEAVYWEIGHT, a black material”, manufactured by HANESBRANDS JAPAN INC., a 100% cotton black material) was used.

Moreover, in Examples 1 to 4 and Comparative Example 2, the pretreatment liquid was applied onto a region scheduled to form the white-based image using a roll coater in advance. The composition of the pretreatment liquid is 5% by mass of calcium nitrate (calcium ion concentration: 1.215% by mass) and 95% by mass of water. In addition, in a case of using the pretreatment liquid, the amount of water included in the pretreatment liquid on the recording medium was set to 100% by mass, and when the amount of water was set to 60% by mass, the white-based ink composition was adhered.

The brightness (L*) of the white-based image which was obtained as described above was measured by a spectrophotometer Gretag Macbeth Spectrolino (trade name, manufactured by X-Rite Inc.). When measuring, a black mount in which the OD value is 2.0 was used as a foundation. The evaluation criteria are as follows.

A: L*=75 or more
B: L*=70 or more and less than 75
C: L*=less than 70

### 3.3.4. Concealing Properties

As to the samples obtained in the same way as the evaluation of the brightness described above, the evaluation of concealing properties was performed. Specifically, each sample was set to a declination colorimeter ARM-500V (product name, manufactured by JASCO Corporation) and the transmittance Tn (%) of each wavelength of every 1 nm was measured in a visible light region (380 nm to 800 nm). The obtained transmittances for each wavelength were integrated to determine the degree of concealment S. The degree of concealment S is a numerical value between 0 and 32,000, the degree of concealment is 0 in a state of being completely shielded (concealed), and the degree of concealment is 32,000 in a state of being completely permeated. The evaluation criteria are as follows.

A: The degree of concealment S is less than 500.
B: The degree of concealment S is 500 or more and less than 1,000.
C: The degree of concealment S is 1,000 or more and less than 1,300.
D: The degree of concealment S is 1,300 or more.

### 3.3.5. Abrasion Resistance

As to the samples obtained in the same way as the evaluation of the brightness described above, the evaluation of abrasion resistance was performed. Specifically, the abrasion resistance was evaluated by confirming a state of peel-off of a printed surface or a state of ink transfer to cotton cloth when the printed surface of a printed matter which was left for 1 hour in a laboratory under a condition of room temperature (25° C.) was rubbed 20 times with a cotton cloth under the load of 200 g using a Color fastness rubbing tester AB-301 (trade name, manufactured by TESTER SANGYO CO., LTD.). Moreover, the evaluation was performed in a laboratory under a condition of room temperature (25° C.) The evaluation criteria of the abrasion resistance are as follows.

A: Peel-off of ink and ink transfer to a cotton cloth were not recognized even rubbing 20 times.
B: Peel-off of ink or ink transfer to a cotton cloth was slightly recognized after rubbing 20 times.
C: Peel-off of ink or ink transfer to a cotton cloth was recognized after rubbing 20 times.
D: Peel-off of ink or ink transfer to cotton cloth was recognized before rubbing 20 times.

### 3.4. Evaluation Results

The results of the above evaluation tests are shown in Table 1.

In the set of the white-based ink composition according to Example and a condensed liquid, it was indicated that it was possible to record the image in which the white-based color material was hard to be precipitated, the liquid repellent film was hard to be damaged due to wiping and the brightness, concealing properties, and the abrasion resistance were excellent.

On the other hand, in Comparative Example 1, since the close-packed type titanium dioxide particles having a large average particle size of 1,000 nm were used as a white-based color material, it was indicated that the sedimentation of the white-based color material or the damage of the liquid repellent film due to wiping occurred. In addition, since the particle size was too large, it was difficult to discharge the close-packed type titanium dioxide particles from the nozzle of the ink jet recording apparatus and it was difficult to conduct the tests for the brightness, concealing properties, and the abrasion resistance.

In Comparative Example 2, since the close-packed type titanium dioxide particles having an average particle size of 300 nm were used as a white-based color material, the damage of the liquid repellent film due to wiping does not occur as much, however, the sedimentation properties of the white-based color material was recognized.

In Comparative Example 3, the white-based color material which was used in Example 1 was used, however, since the pretreatment liquid was not used, it was indicated that the flocculant of the white-based color material did not occur and the brightness and concealing properties of the recorded white-based image became insufficient.

Apart from the above evaluation tests, as to the white-based ink compositions in Example 2 and Comparative Example 2, the states before and after the flocculation of the white-based color material due to the pretreatment liquid were observed by a SEM.

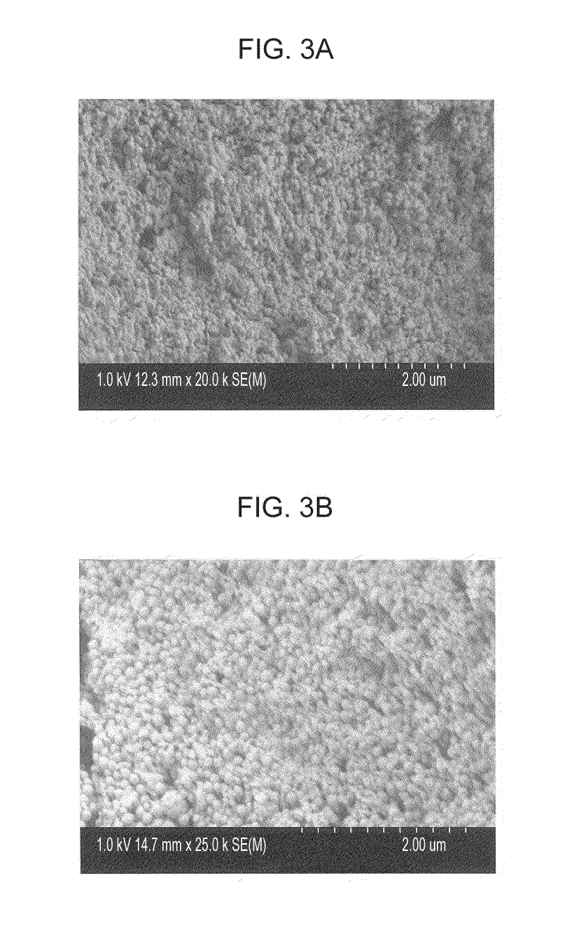

FIGS. 3A and 3B are SEM images showing states before and after the flocculation of a white-based color material of Example 2. Specifically, FIG. 3A is one in which the image obtained by discharging the white-based ink composition of Example 2 onto the recording medium onto which the pretreatment liquid was not applied was observed by a SEM. In addition, FIG. 3B is one in which the image obtained by discharging the white-based ink composition of Example 2 onto the recording medium onto which the pretreatment liquid was applied was observed by a SEM.

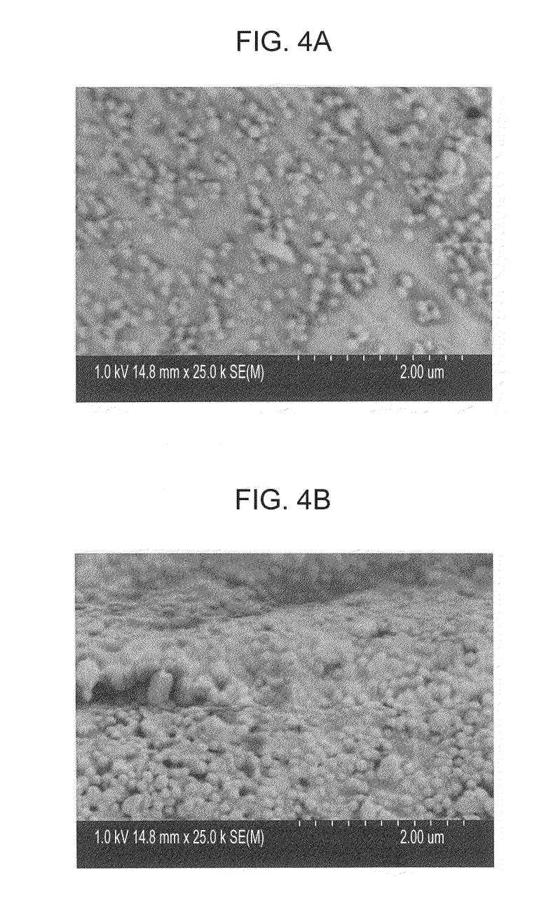

FIGS. 4A and 4B are SEM images showing states before and after the flocculation of a white-based color material of Comparative Example 2. Specifically, FIG. 4A is one in which the image obtained by discharging the white-based ink composition of Comparative Example 2 onto the recording medium onto which the pretreatment liquid was not applied was observed by a SEM. In addition, FIG. 4B is one in which the image obtained by discharging the white-based ink composition of Comparative Example 2 onto the recording medium onto which the pretreatment liquid was applied was observed by a SEM.

As shown in FIGS. 3A to 4B, it was indicated that the white-based color material was flocculated by reacting with the pretreatment liquid. Specifically, the images of FIGS. 3A and 3B show that the shape of the particles in FIG. 3B is clearly appeared, compared to the shape of the particles in FIG. 3A. From this, it can be said that as to the particles in FIG. 3B, the particles are aggregated each other and densely flocculated.

The invention is not limited to the embodiment described above and various modifications are possible. For example, the invention includes substantially the same configuration as the configuration described in the embodiment (for example, the configuration having the same function, method and, result or the configuration having the same object and advantage). In addition, the invention includes a configuration in which an inessential part of the configuration described in the embodiment is replaced. In addition, the invention includes a configuration which exhibits the same working effect or a configuration which can achieves the same object as those of the configuration described in the embodiment. In addition, the invention includes a configuration imparting a well-known art to the configuration described in the embodiment.

The entire disclosure of Japanese Patent Application No. 2013-218099, filed Oct. 21, 2013 is expressly incorporated by reference herein.

What is claimed is:

1. A set of an ink and a pretreatment liquid, comprising:
a white-based ink composition containing a white-based color material; and
a pretreatment liquid containing a flocculant,
wherein the white-based color material consists of second particles which have an average particle size from 200 nm to 1 μm and which are formed by aggregating a plurality of first particles having an average particle size of less than 200 nm, and
wherein the flocculant flocculates the second particles.

2. The set of an ink and a pretreatment liquid according to claim 1,
wherein the white-based ink composition is adhered onto a region of a recording medium onto which the pretreatment liquid is imparted so that the white-based color material is 0.1 mg/cm² or more.

3. The set of an ink and a pretreatment liquid according to claim 1,
wherein the white-based ink composition further includes a resin, and
wherein the content of the white-based color material is from 0.2 times to 20 times in terms of a solid content with respect to the content of the resin.

4. The set of an ink and a pretreatment liquid according to claim 1,
wherein the white-based ink composition is used for an ink jet recording apparatus, and
wherein the ink jet recording apparatus is provided with a pressurizing section for pressurizing an image obtained by adhering the white-based ink composition onto a recording medium.

5. The set of an ink and a pretreatment liquid according to claim 1,
wherein the white-based ink composition is an ultraviolet ray curable type ink which is cured by irradiating with an ultraviolet ray and includes a polymerizable compound.

6. The set of an ink and a pretreatment liquid according to claim 1,
wherein the white-based ink composition is used for recording to an ink-non-absorbing recording medium.

7. The set of an ink and a pretreatment liquid according to claim 1,
wherein the white-based ink composition is brought into contact with the pretreatment liquid in a state in which the pretreatment liquid adhered onto a recording medium is wet.

8. The set of an ink and a pretreatment liquid according to claim 1,
wherein the white-based ink composition is used for an ink jet recording apparatus,
wherein the ink jet recording apparatus is provided with a nozzle forming surface on which a nozzle discharging an ink is arranged, a wiping section for wiping the nozzle forming surface, and a cleaning liquid imparting section for imparting a cleaning liquid to the wiping section or the nozzle forming surface, and
wherein the surface tension of the cleaning liquid is from 20 mN/m to 45 mN/m.
